(19) United States
(12) Patent Application Publication
(10) Pub. No.: US 2017/0371918 A1
(43) Pub. Date: Dec. 28, 2017

(54) PLAYER NETWORK

(71) Applicants: Swupnil Kumar Sahai, Saratoga, CA (US); Richard Hsu, Irvine, CA (US)

(72) Inventors: Swupnil Kumar Sahai, Saratoga, CA (US); Richard Hsu, Irvine, CA (US)

(21) Appl. No.: 15/189,999

(22) Filed: Jun. 22, 2016

(51) Int. Cl. G06F 17/30; H04L 29/08

(52) U.S. Cl. CPC G06F 17/30377; G06F 17/30867; G06F 17/3056; H04L 67/26

(57) ABSTRACT

A system and method for a player network can include: obtaining a set of parameters pertaining to a sports match during a participation of a player in the sports match; and obtaining the parameters during the sports match and in response to the parameters providing a user of a player networking service with access to a set of information pertaining to the sports match.

### BACKGROUND

A social network can enable its users to share selected bits and pieces of their lives online. For example, a social network can enable its users to post photographs, videos, and messages, to share news stories, and to share, reply, and comment on postings of other users.

A social network can generate news feeds for its users. For example, a social network can enable its users to form networking relationships, e.g., friends, following, etc., and then generate news feeds among its users based on those relationships.

### SUMMARY

In general, in one aspect, the invention relates to a player network. The player network can include: a device associated with a player in the player network that obtains a set of parameters pertaining to a sports match during a participation of the player in the sports match; and a player networking service that obtains the parameters from the device and that in response to the parameters provides a user of the player networking service with access to a set of information pertaining to the sports match.

In general, in another aspect, the invention relates to a method for a player network. The method can include: obtaining a set of parameters pertaining to a sports match during a participation of a player in the sports match; and obtaining the parameters during the sports match and in response to the parameters providing a user of a player networking service with access to a set of information pertaining to the sports match.

In general, in another aspect, the invention relates to a player networking service. The player networking service can include: a venue registration module that enables a first player registered with the player networking service to use a client device of the first player to register a sports venue with the player networking service; a venue review store for holding a set of venue reviews for the sports venue registered by the first player; and a venue review module that enables a second player registered with the player networking service to access the venue reviews using a client device of the second player.

Other aspects of the invention will be apparent from the following description and the appended claims.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 illustrates a player network in one or more embodiments.

FIG. 2 illustrates an example embodiment of a player network in which a smart-device worn by a player models a tennis match.

FIGS. 3A-3B show examples of a set of stats for a player displayed on a device worn by the player.

FIGS. 4A-4F illustrate a set of screens on a client device of a player networking service that enable a user to browse player and match and venue information.

FIG. 5 illustrates elements a device worn by a player in a player network in one or more embodiments.

FIG. 6 illustrates elements of a player networking service in one or more embodiments.

FIG. 7 illustrates a method for a player network in one or more embodiments.

FIG. 8A illustrates a player networking service in one or more embodiments that enables player reviews of sports match venues.

FIG. 8B shows an example of a player review of a sports match venue in one or more embodiments.

FIG. 9 illustrates a computing system upon which portions of a player networking service can be implemented.

### DETAILED DESCRIPTION

Reference will now be made in detail to the various embodiments of the present disclosure, examples of which are illustrated in the accompanying drawings. Like elements in the various figures are denoted by like reference numerals for consistency. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, have not been described in detail so as not to unnecessarily obscure aspects of the present disclosure.

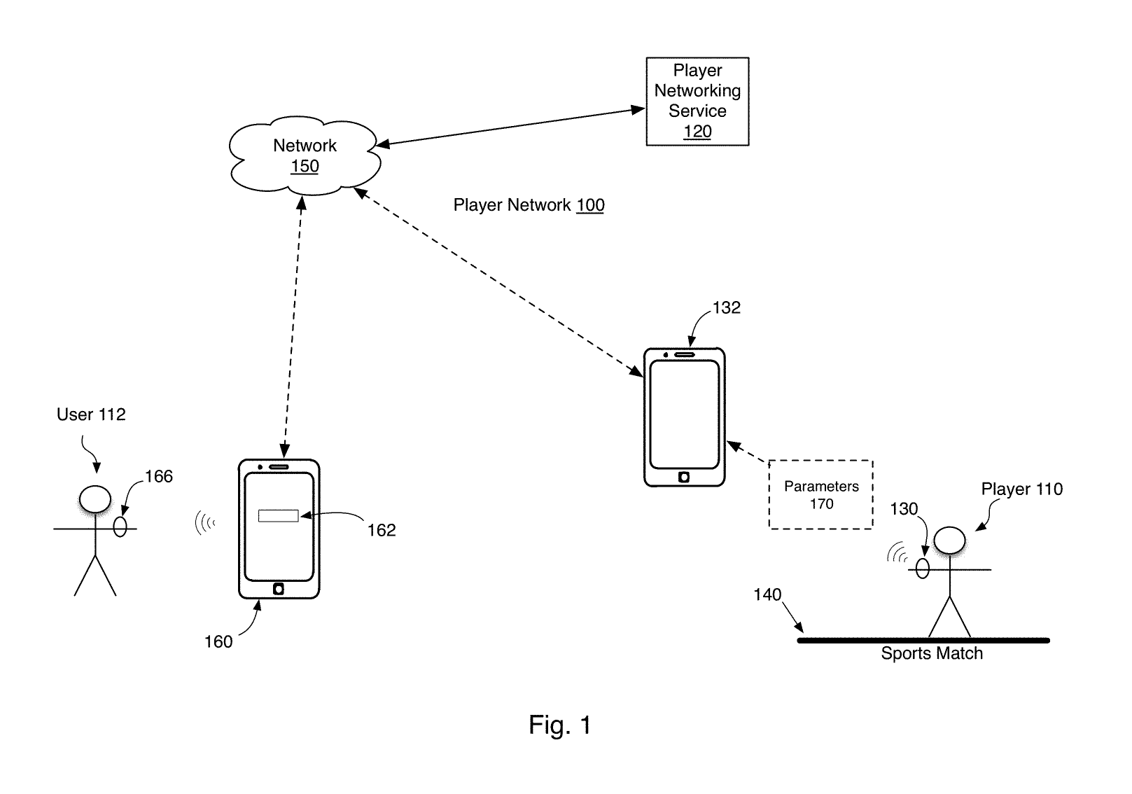

FIG. 1 illustrates a player network 100 in one or more embodiments. The player network 100 includes a device 130 associated with a player 110. The device 130 obtains a set of parameters 170 pertaining to a sports match 140 during a participation of the player 110 in the sports match 140. The player network 100 further includes a player networking service 120 that obtains the parameters 170 from the device 130. The player networking service 120 in response to the parameters 170 provides a user 112 of the player networking service 120 with access to a set of information 162 pertaining to the sports match 140.

The parameters 170 in one or more embodiments provide a description of a current state of the sports match 140. For example, the parameters 170 can include a current score of the sports match 140 and a current set of stats for the player 110. The parameters 170 can include information pertaining to a venue of the sports match 140.

The information 162 can include any information pertaining to the sports match 140 that can be derived from the parameters 170 and from information maintained by the player networking service 120. Examples of the information 162 include a score of the sports match 140, a set of stats pertaining to the sports match 140, posts made by users of the player networking service 120 pertaining to the sports match 140, and information pertaining to a venue of the sports match 140.

The information 162 can be provided to the user 112 in a push notification via a network 150 from the player networking service 120 to a client device of the user 112, e.g., to a mobile device 160, a wearable device 166, or a computer/laptop, etc., of the user 112. The player networking service 120 can provide a client device of the user 112 with access to the information 162 using apps that run on the client device and that are adapted to accessing the player networking service 120. The player networking service 120 can provide a client device of the user 112 with access to the information 162 using web protocols.

The sports match 140 can be any type sports match. Examples of types include tennis, golf, bowling, baseball, football, basketball, soccer, intramural sports, rowing, chess, fantasy sports, video game tournaments, gambling events, hockey, winter sports, track and field, cricket, etc.

In one or more embodiments, the player networking service 120 sends the user 112 a push notification every time something significant happens in the sports match 140. An example of a push notification if the sports match 140 is a tennis match is “John Smith just won the first set against Rey Brown”. Another example if the sports match 140 is a tennis match is “John Smith now leads 6-4 7-6 against Rey Brown”. An example of a push notification if the sports match 140 is a golf match is “John Smith just birdied the fourth hole at Oakmont”. An example if the sports match 140 is a basketball game is “John Smith just sank a three-pointer in the fourth quarter”.

The information 162 can include a ranking of the player 110. A ranking of the player 110 can be based on any one or more of a set of stats associated with the player 110.

The player networking service 120 in one or more embodiments enables the user 112 to post a message pertaining to the sports match 140. For example, the user 112 can be a friend of the player 110 who can encourage or coach the player 110 during the sports match 140 by posting a virtual cheer or a comment in text or other form.

In one or more embodiments, the device 130 includes a player interface that enables the player 110 to enter inputs describing their performance during the sports match 140. For example, a player interface for a tennis match can enable the player 110 to enter “won” or “lost” for each set of a match, or for each game of the match, or for each point of the match, enter indicators of service aces, faults, etc. In another example, a player interface for a golf match can enable the player 110 to enter a score for each hole, indicators for birdies, bogies, pars, three-puts, etc. In yet another example, a player interface for a baseball game can enable the player 110 to enter “single”, “double”, “triple”, “homerun”, “walk”, “ground out”, “fly out”, “strikeout”, etc., when hitting, and “strikeout”, “walk”, “hit batter”, etc., when pitching

In one or more embodiments, the device 130 updates the parameters 170 in response to each input made by the player 110 via the player interface of the device 130. The device 130 can upload the parameters 170 to the player networking service 120 via a mobile device 132, e.g., a smart-phone, belonging to the player 110.

In one or more other embodiments, the device 130 uploads the inputs made by the player 110 to the mobile device 132 of the player 110 and the mobile device 132 generates the parameters 170 from the inputs made by the player 110. In still other embodiments, the device 130 uploads the inputs made by the player 110 to the player networking service 120 and the player networking service 120 generates the parameters 170 from the inputs made by the player 110.

In one or more embodiments, the device 130 is a wearable device, e.g., a smart-watch, that runs an app adapted to a type of the sports match 140 and the app generates the player interface and generates the parameters 170 using a model of the sports match 140. For example, the player 110 when playing a tennis match can run a tennis app on the device 130, and when playing a golf match can run a golf app on the device 130, etc. In other embodiments, the device 130 can be a device specifically adapted to a particular sport, e.g., a wearable with buttons and displays adapted for tennis, or a wearable for golf, etc.

In one or more embodiments, the information 162 is provided to the user 112 using a push notification from the player networking service 120 so that the user 112 sees the information 162 even when using some other app on the device 166 or the device 160 or when not using any device. For example, the information 162 can appear on the locked home screen of the mobile device 160 and can be accompanied by a sound or vibration, etc. If the device 166 is a smart-watch, the information 162 can appear just beneath a clock face of the smart-watch when the user 112 raises a wrist to look at the time, i.e., the information 162 can be rendered as a complication in smart-watch terminology.

A model of the sports match 140 can be derived from a set of rules for a particular sport. For example, a model for a tennis match can be derived from a set of rules of tennis, e.g., a score progression of 0-15-30-40-AD, games grouped in sets, rules for winning sets, etc. Likewise, a model for a golf match can be derived from the scoring rules of golf and a model for a baseball match from the scoring rules of baseball, etc.

The device 130 can periodically upload a current state of the parameters 170 during the course of the sports match 140 and the player networking service 120 can provide updated push notifications to the user 112 in response to the updated parameters 170. This can provide a “game ticker” that enables the user 112 and other friends of the player 110 to stay updated on the sports match 140 and the performance of the player 110 in the sports match 140.

In one or more embodiments, the device 130 obtains a set of health information pertaining to the player 110. For example, the device 130 can include the capability of measuring the heart rate, calories burned, running distance, etc., for the player 110. The health information can be used to derive health-related stats included in the parameters 170 and displayed on the device 130.

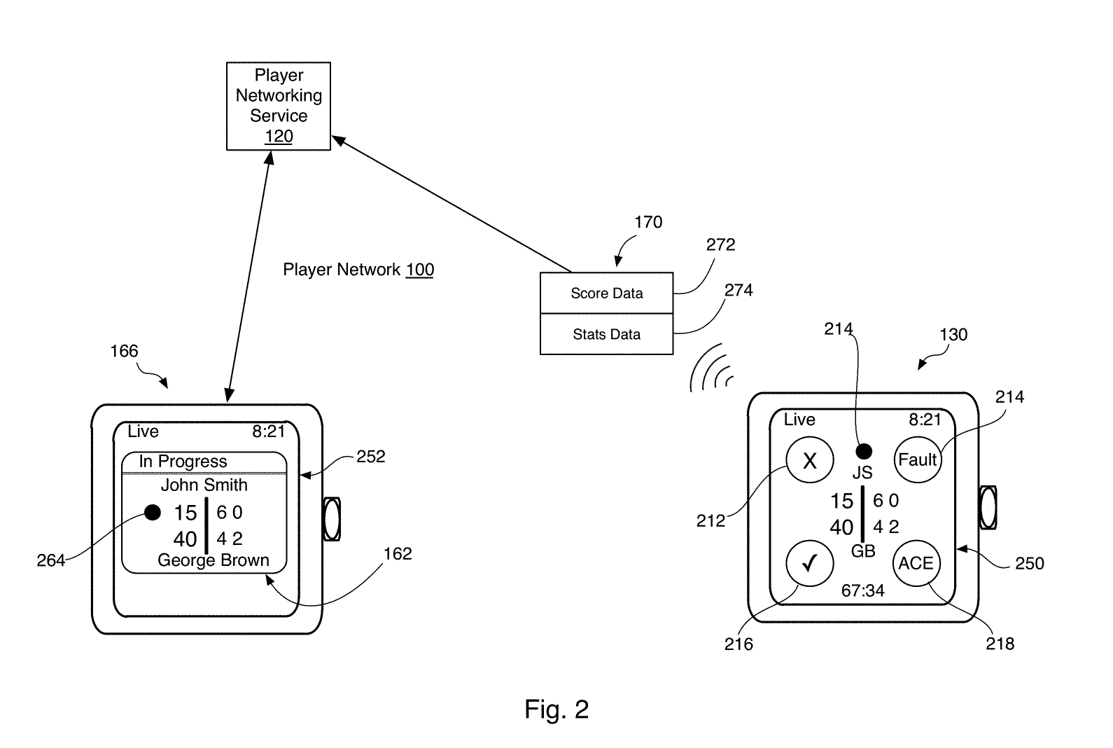

FIG. 2 illustrates an example embodiment of the player network 100 in which the device 130 is a smart-watch running a tennis app that models a tennis match. The tennis app generates a player interface on a touchscreen 250 of the device 130 including a set of buttons 212-218 that enable the player 110 to enter inputs that describe the sports match 140 according to the tennis model.

The parameters 170 in this example embodiment include a set of score data 272 for a tennis match and a set of stats data 274 for the player 110. The score data 272 is reflected on the touchscreen 250 in a current game score and a set score.

The touchscreen 250 shows that the player 110 (John Smith—JS) is down 15-40 in the current game to George Brown (GB). The touchscreen 250 includes indicator 214 that John Smith has the serve. The touchscreen 250 shows that John Smith has won the first set 6 games to 4 but is down 0 games to 2 in the second set.

The player 110, George Brown, describes the progress of the sports match 140 by tapping the button 212 after losing a point, by tapping the button 216 after winning a point, by tapping the button 214 after George or his opponent serves a fault, and by tapping the button 218 after George or his opponent serves an ace. In response, the tennis app updates the parameters 170 and the touchscreen 250 score based on the model of a tennis match.

For example, when George Brown taps the button 212, the tennis app updates the score of the current game to 30-40 on the touchscreen 250 and in the score data 272. If a newly won point wins the current game, then the tennis app increases the game tally for George Brown on the touchscreen 250 and in the score data 272. If a newly won point wins the current set, then the tennis app increases a set tally for George Brown in the score data 272 and on the touchscreen 250. Likewise, when George Brown taps the button 218 after serving an ace, the tennis app updates the scores accordingly and updates the stats data 274 to indicate the ace by whichever player is currently serving.

In some embodiments, when George Brown taps the win or the lose buttons 216 or 212, the tennis app running on the device 130 generates a second screen of buttons on the touchscreen 250 that enable George to input additional details about how a point ended, e.g., “unforced error”, “winner”, or “forced error”. The tennis app uses the additional inputs to update the stats data 274.

In some embodiments, a bystander, e.g., a friend or game official, can enter the descriptive inputs via a device, e.g., a smart wearable device or a mobile device that runs a tennis app, while watching the player 110 play in the tennis match.

The information 162 in this example is a push notification to the device 166, which in this example is a smart-watch of the user 112 with a touchscreen 252. The device 166 runs a client app for receiving push notifications from the player networking service 120. The information 162 includes the current game score of 15-40 and the set scores 6-4 and 0-2 along with an indicator 264 that John Smith is serving.

The tennis app on the device 130 can periodically upload a current state of the parameters 170 during the course of a tennis match. For example, the tennis app can upload an updated version of the parameters 170 after each point, after each game, or after each set, or in response to a prompt by the player 110, etc. The player networking service 120 can generate an update of the information 162 for each update to the parameters 170. The player networking service 120 detect significant events/milestones in the sports match 140 in response to the updated parameters 170 and provide an update of the information 162 to the user 112 accordingly.

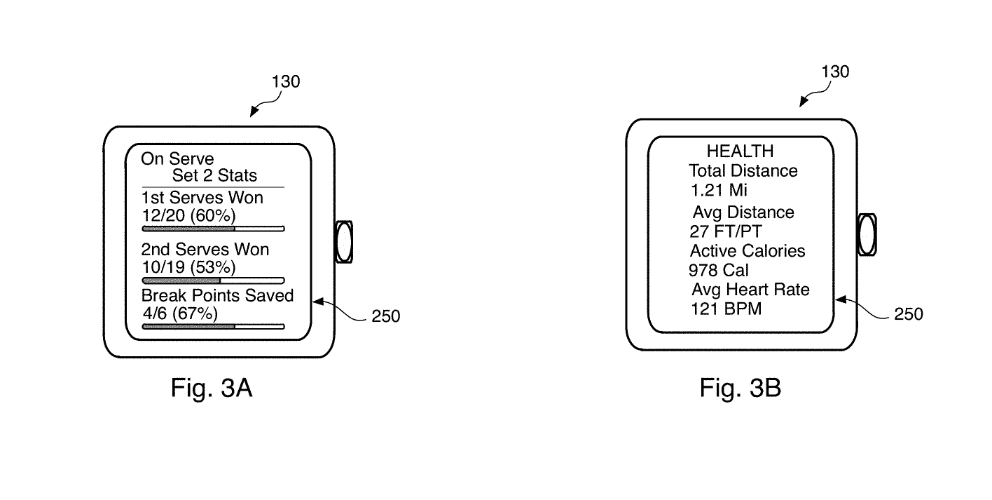

FIGS. 3A-3B show examples of the stats 274 for the player 110 displayed on the touchscreen 250 of the device 130 embodied as a smart-watch. FIG. 3A shows a screen generated by a tennis app that depicts the stats for the player 110 for the current set—set 2. The set 2 stats depicted on the touchscreen 250 in this example include first serves won, second serves won, and break points saved.

FIG. 3B shows a screen that depicts stats for the player 110 derived from a set of health functions of built into the underlying smart-watch. The health function derived stats in this example include the total distance run by the player 110 in the sports match 140, the average distance in feet per point, the calories burned, and average heart rate during the sports match 140.

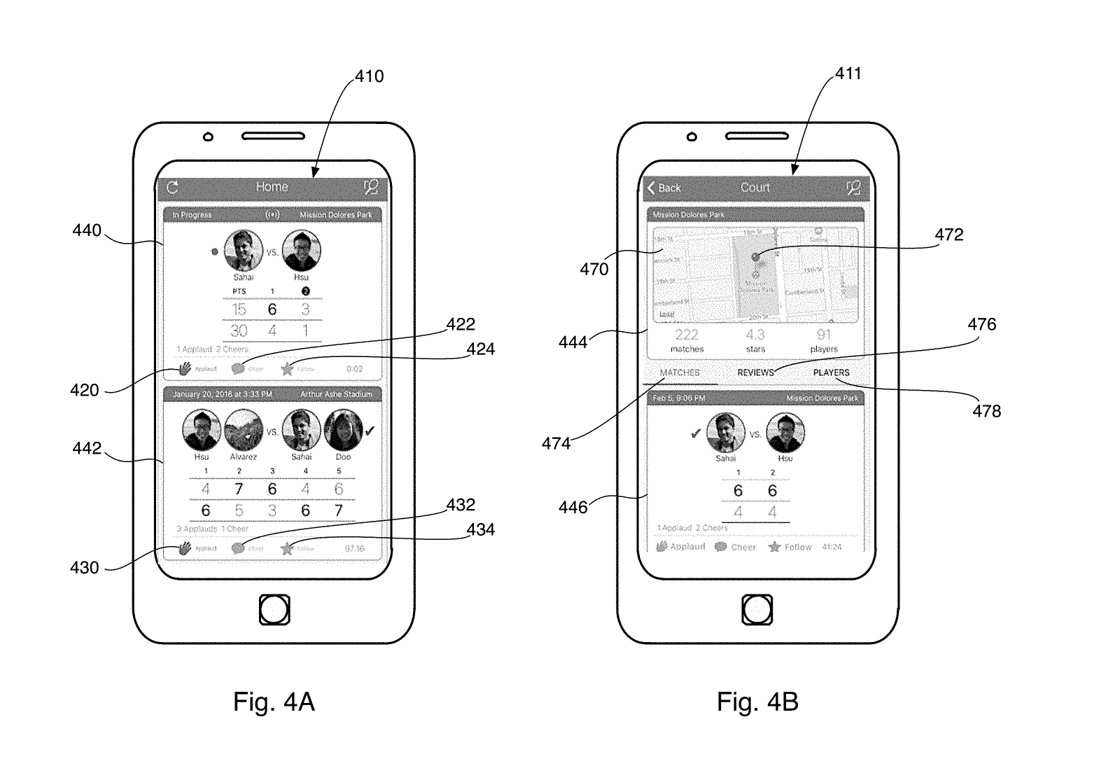

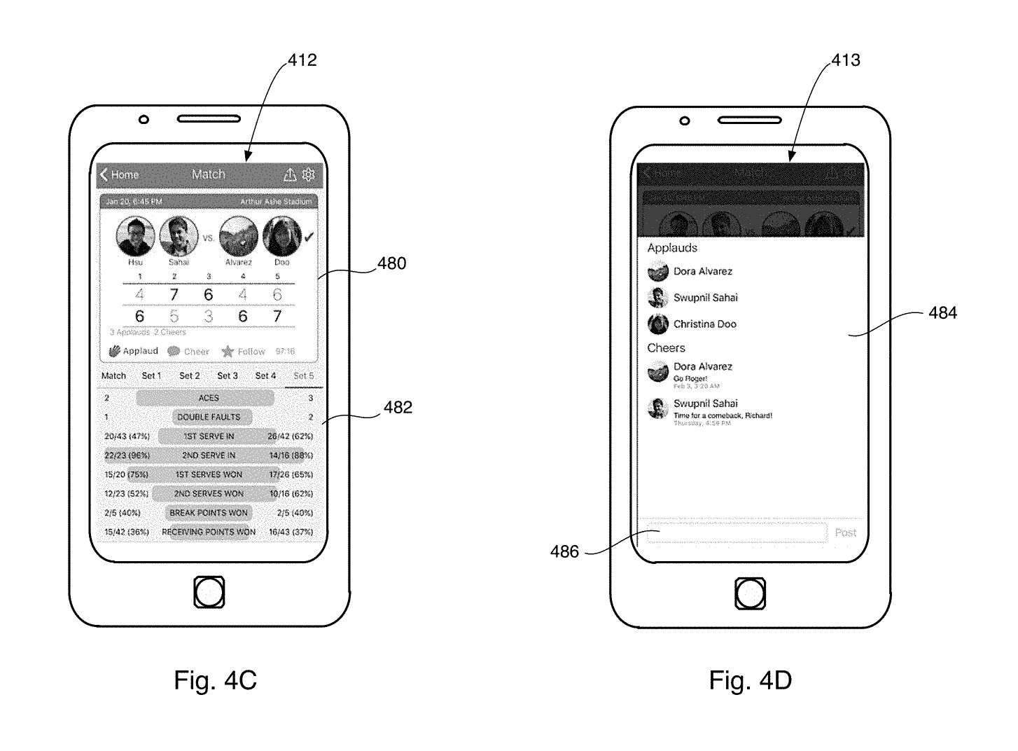

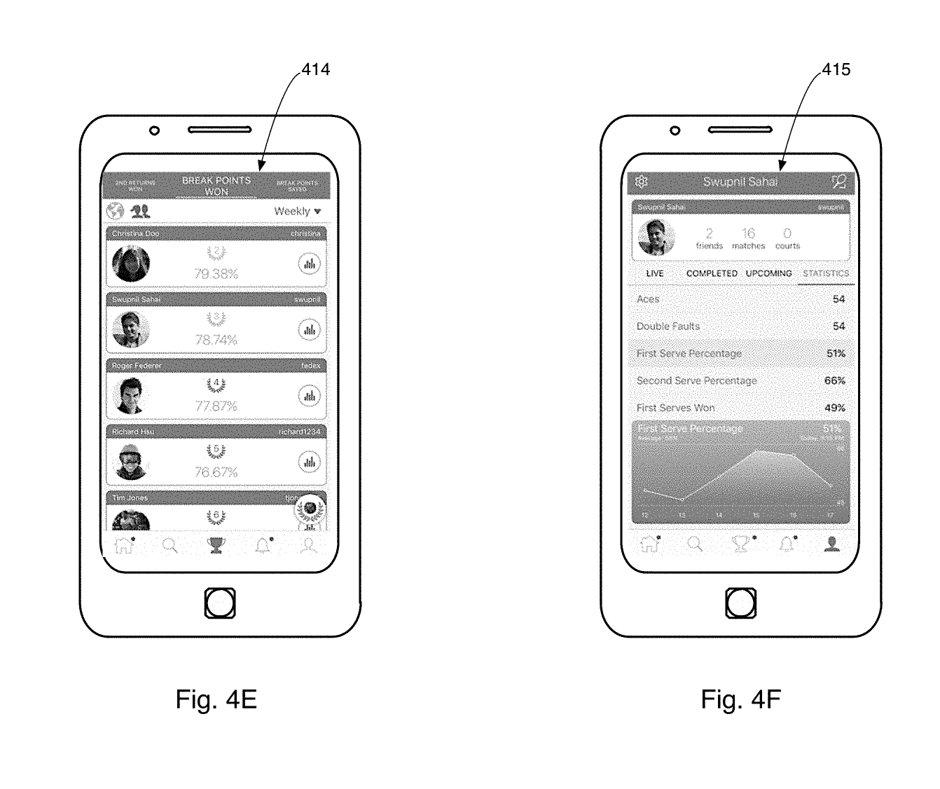

FIGS. 4A-4F illustrate a set of screens on a client device of the player networking service 120 that enable a user of the player networking service 120 to access player information in one or more embodiments of the player networking service 120 based on the sport of tennis. For example, the client device depicted in FIGS. 4A-4F can be the mobile device 132 of the player 110, the mobile device 160 of the user 112, or some other client device of the player networking service 120. The information depicted is derived from the parameters obtained by the player networking service 120 from devices worn by the players involved the depicted matches, e.g., the parameters 170 from the device 130.

FIG. 4A shows a screen 410 that enables a user to browse match information on the player networking service 120. The screen 410 in this example includes a view 440 of a singles match, Sahai v. Hsu, currently underway at Mission Delores Park, and a view 442 of a doubles match already completed at Arthur Ashe Stadium and won by Sahai and Doo.

Each view 440 and 442 includes a set of buttons that enable a user to virtually applaud a match, enter a cheer for a match, and follow a match. For example, the view 440 includes an applaud button 420 that enables a user to virtually applaud the Sahai v. Hsu match, a cheer button 422 that enables the user to post a cheer for the Sahai v. Hsu match, and a follow button 424 that enables the user to follow the Sahai v. Hsu match, e.g., receive push notifications pertaining to the Sahai v. Hsu match. Likewise, the view 442 includes an applaud button 430, a cheer button 432, and a follow button 434 for the doubles match.

FIG. 4B shows a screen 411 that provides a set of information pertaining to a venue for a match. In this example, the screen 411 includes a view 444 with information pertaining to a tennis court at Mission Delores Park. The view 444 includes an interactive map 470 with an indicator 472 of a location of the Mission Delores Park court. In one or more embodiments, a user can tap on the interactive map 470 to obtain driving directions. The view 444 includes a tally (222) of the number of matches at the Mission Delores Park court, a star rating, e.g., 4.3/5, for the court, and the number of players (91) in the player network 120 who have played on the Mission Delores Park court.

The screen 411 includes a button 474 that enables a user to browse a list of matches played at the Mission Delores Park court including a view 446 of the now completed Sahai v. Hsu match won by Sahai 6-4, 6-4. The screen 411 includes a button 478 that enables a user to browse a list of players who have played at the Mission Delores Park court. The screen 411 includes a button 476 that enables a user to browse reviews of the Mission Delores Park court. A review can include a rating, e.g., a star rating, and comments about the venue, e.g. ease of parking, type and quality of the court surface, lighting, etc.

FIG. 4C shows a screen 412 that includes a view 480 of a summary of the doubles match at Arthur Ashe Stadium won by Sahai and Doo. The screen 412 includes a view 482 with the stats for the doubles match broken down by set and showing the stats for set 5.

FIG. 4D shows a screen 413 when a user taps a cheer button, e.g., the cheer button 432 (FIG. 4A), for the doubles match Arthur Ashe Stadium. The screen 413 includes a view 484 with existing applauds and cheers and includes a text input field 486 that enables a user to enter a cheer message. For example, a user can tap on the text input field 486 to bring up a keyboard.

FIG. 4E shows a screen 414 with a leaderboard of player rankings. In this example, the player rankings are based on a “break points won” statistic derived from the parameters obtained from the devices worn by the players registered with the player networking service 120. The screen 414 enables a user to swipe back to see player rankings by “2nd returns won”, or swipe forward to see player rankings by “break points saved”. The player rankings can be rankings within a “friends” network of a user or among the general public. The player networking service 120 can provide a user with a setting to control how far back in time to obtain the rankings, e.g., weekly, monthly, yearly, or all time.

FIG. 4F shows a screen 415 that enables a user to see a set of information pertaining a player. The screen 415 includes a set of buttons that enable the user to see live, completed, and upcoming matches for the player. The user in this example has selected a statistics button that shows summaries of a set of statistics for the player.

In one or more embodiments, the player networking service 120 enables a user registered with the player networking service 120 to view head-to-head player comparisons. For example, the player networking service 120 can generate a screen on a client device that enables a user to select a pair of players who are registered with the player networking service 120 and the player networking service 120 can then display a set of statistics and other player information of each of the two selected players against one another for a side-by-side comparison on-screen on the client device.

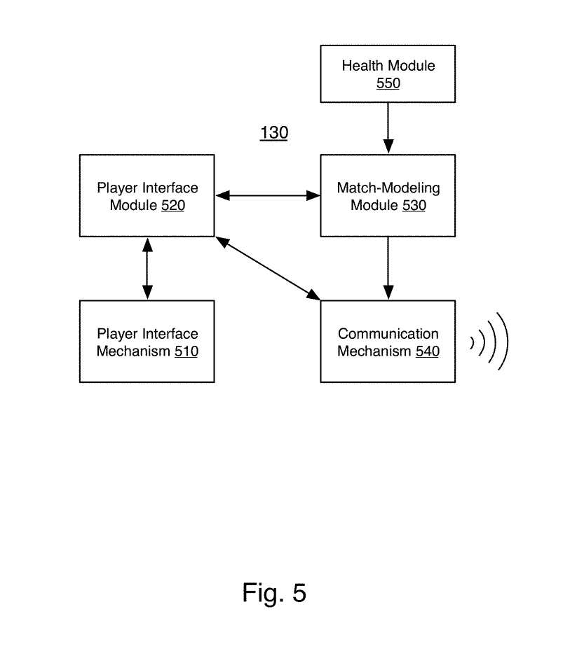

FIG. 5 illustrates elements of the device 130 in one or more embodiments. The device 130 includes a player interface mechanism 510. The player interface mechanism 510 can include an input mechanism, e.g., a touchscreen, buttons, etc., and a display mechanism, e.g., a touchscreen or other display mechanism. The player interface mechanism 510 can in some embodiments include speech recognition functionality to obtain inputs verbally.

The device 130 includes a player interface module 520 that generates a player interface using the player interface mechanism 510. For example, the player interface module 520 can use the player interface mechanism 510 to generate an arrangement of screens and buttons and displays to the player 110 and to obtain inputs from the player 110

The device 130 includes a match-modeling module 530 that obtains the inputs made by the player 110 from the player interface module 520. In response to the inputs from the player 110, the match-modeling module 530 generates the parameters 170 using a model of the sports match 140. The match-modeling module 530 can include a score tracking function that keeps track of a current score of the sports match 140 according to a model of the sports match 140 and a stats generating function that keeps track of stats for the player 110 during the sports match 140 according to the model. The match-modeling module 530 provides score and stats data back to the player interface module 520 for display to the player 110.

The device 130 includes a health module 550 that includes health-monitoring functions, e.g., heart rate, running distance, etc. The match-modeling module 530 can include health data from the health module 550 in the stats data for the player 110.

The device 130 includes a communication mechanism 540 that enables communication with the mobile device 132 of the player 110 or with the player networking service 120 via the network 150. For example, the communication mechanism 540 can enable communication according to a wireless communication protocol such as Bluetooth or Wi-Fi, etc. The communication mechanism 540 enables the match-modeling module 530 to upload the parameters 170. The communication mechanism 540 can also enable the player interface module 520 to access the player networking service 120 and obtain information that can be displayed to the player 110 via the player interface mechanism 510.

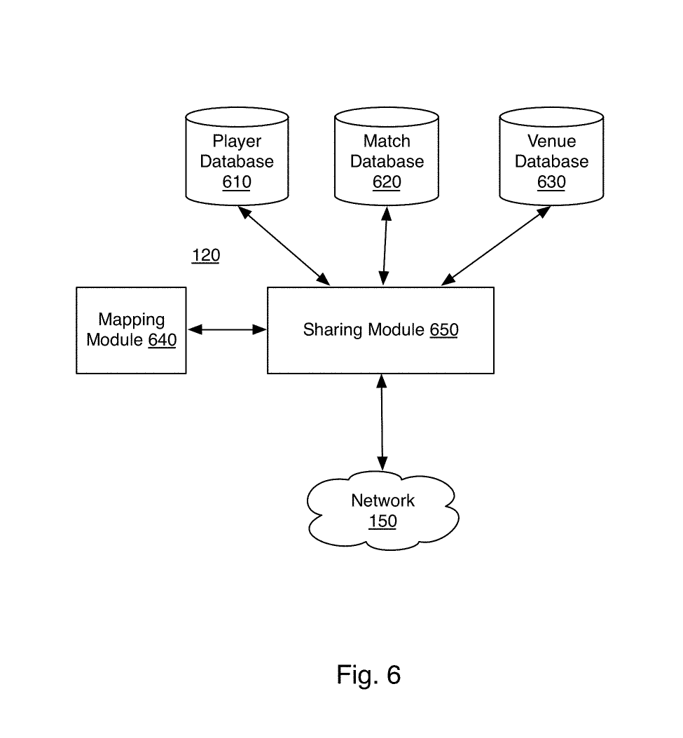

FIG. 6 illustrates elements of the player networking service 120 in one or more embodiments. The player networking service 120 includes a player database 610 for holding a set of information for each registered user of the player networking service 120, e.g., profile photos, personal information, player profiles, stats, skill levels, etc.

The player networking service 120 includes a match database 620 for holding a set of information for each of a set of matches shared via the player networking service 120. The information for a match in the match database 620 can include the players, the venue, scores and stats, cheers and comments, etc.

The player networking service 120 includes a venue database 630 for holding a set of information for each of a set of venues for matches shared via the player networking service 120. The information for a venue in the venue database 630 can include location information, reviews and ratings, a list of players who have played there, a list of matches played there, etc.

The player networking service 120 includes a sharing module 650 that enable users of the player networking service 120 to schedule matches and access the information pertaining to the scheduled matches from the player database 610 and the match database 620 and the venue database 630. The sharing module 650 communicates with client devices of the player networking service 120 via the network 150 to provide the client devices with the push notifications and the user interfaces described above. The sharing module 650 can invoke a mapping module 640 to provide interactive maps to client devices of the player networking service 120.

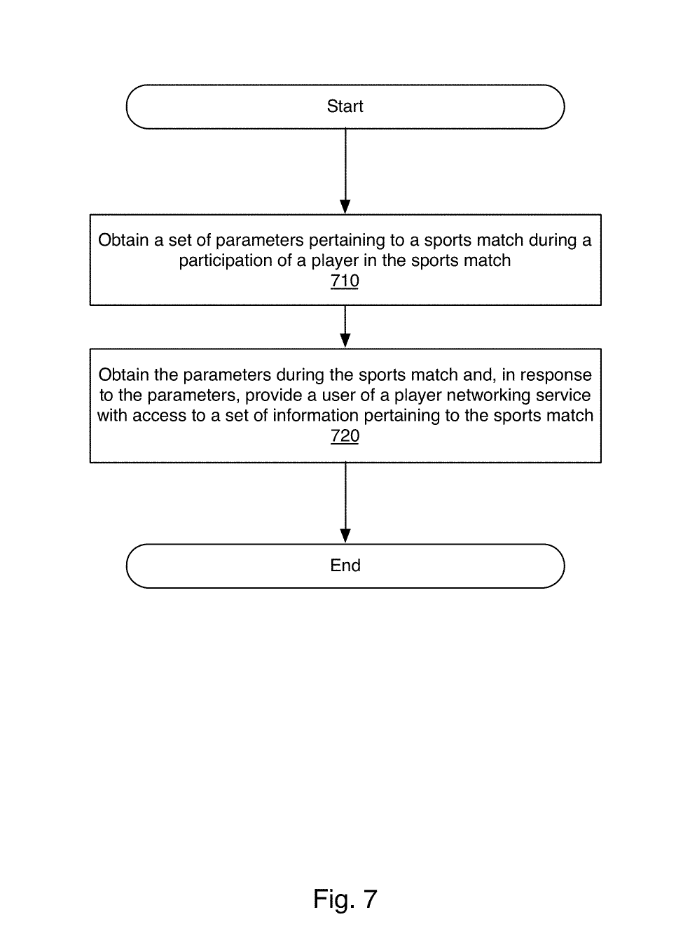

FIG. 7 illustrates a method for a player network in one or more embodiments. While the various steps in this flowchart are presented and described sequentially, one of ordinary skill will appreciate that some or all of the steps can be executed in different orders and some or all of the steps can be executed in parallel. Further, in one or more embodiments, one or more of the steps described below can be omitted, repeated, and/or performed in a different order. Accordingly, the specific arrangement of steps shown in FIG. 7 should not be construed as limiting the scope of the invention.

At step 710, a set of parameters pertaining to a sports match are obtained during a participation of a player in the sports match. The parameters can be obtained by obtaining inputs from the player that describe the participation. The inputs can be used to determine score and stats parameters using a model of the sports match.

At step 720, the parameters are obtained during the sports match and, in response to the obtained parameters, a user of a player networking service is provided with access to a set of information pertaining to the sports match. The access to the information can be provided to the user via a push notification to the user. The user can obtain the information by accessing and browsing the player networking service.

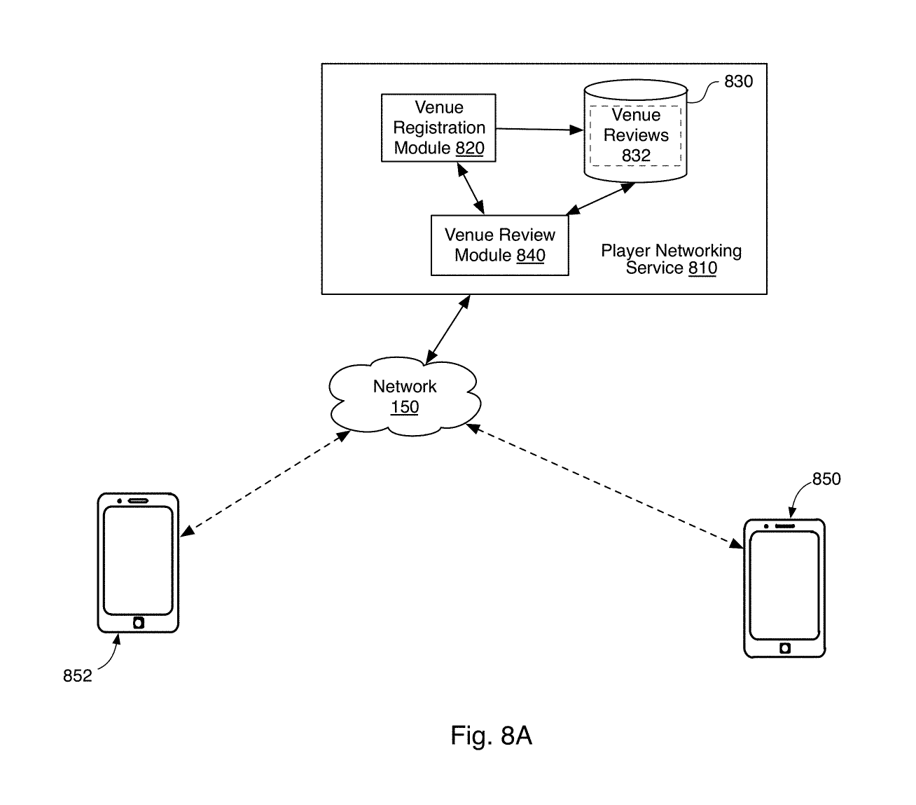

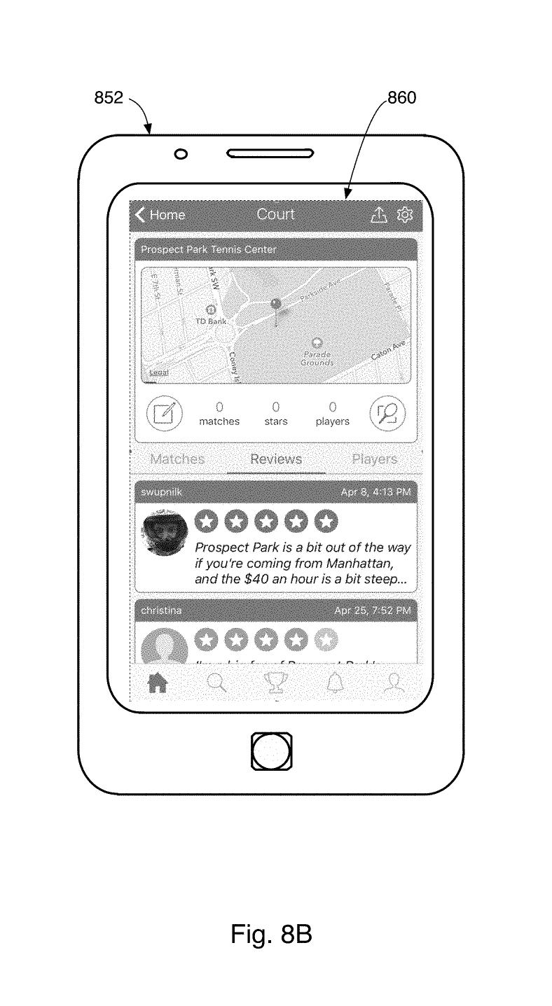

FIG. 8A shows a player networking service 810 in one or more embodiments that enables player reviews of sports venues. The player networking service 810 includes a venue registration module 820 that enables players registered with the player networking service 810 to register sports venues with the player networking service 810. For example, a player can use a client device 850 to register a sports venue with the player networking service 810. Any player registered with the player networking service 810 can register any number of sports venues.

In one or more embodiments, the venue registration module 820 generates user interface elements on the client devices of players to enable the process of sports venue registration. For example, a mobile app, web app, browser app, etc., running on the client device 850 can facilitate sports venue registration.

The player networking service 810 includes a venue review store 830 for holding a set of venue reviews 832 for the sports venues registered by the players. The venue reviews 832 can include venue reviews based on personal experiences of the players. The venue reviews 832 can be text reviews, star ratings, number ratings, audio/video reviews, etc., or any combination.

The venue reviews 832 can have a structure that is adapted to a particular type of sports match. For example, a venue review for a tennis match can be broken down into categories such as court surface, surface quality, net quality, lighting quality, ambient conditions, noise, distractions, etc.

The player networking service 810 includes a venue review module 840 that enables players registered with the player networking service 810 to access the venue reviews 832 using client devices of the players. For example, a player can use the client device 850 to access the venue reviews 832 via the venue review module 840. In one or more embodiments, the venue review module 840 generates user interface elements on the client devices of players that enable the players to search the venue reviews 832 and update and add to the venue reviews 832, e.g., via a mobile app, web app, browser app, etc., running on the client devices.

In one or more embodiments, the venue registration module 820 enables the players to register the sports venues by enabling the players to provide a set of descriptive information pertaining to the sports venues. For example, the venue registration module 820 can generate input fields for descriptive information on the client device 850 during the registration process. The descriptive information can be used uniquely identify a sports venue to the player networking service 810 and link to the corresponding venue reviews in the venue review store 830.

The descriptive information for a sports venue can be any information that can be used to uniquely identify the corresponding sports venue to the player networking service 810. The descriptive information can be an official name of a venue, e.g., “A1 Tennis Courts”, “Broadway High Tennis Courts”, “Wimbledon Grandstand”, etc. The descriptive information can be colloquial or by common usage among players, a nickname, e.g., “5th Street Field”, “Ryon Park East”, “Abandoned City Lot”, etc. The descriptive information can be location information for a venue, e.g., street address, coordinates, dead-reckoning navigation information, etc.

In one or more embodiments, the venue review module 840 enables the players to search the venue reviews 832 using the descriptive information. For example, the venue review module 840 can generate input fields for search terms on the client device 850 that enable a player to search for and obtain the venue reviews of particular sports venues by their description.

In one or more embodiments, the venue review module 840 enables the players to add to the venue reviews 832 using the descriptive information. For example, the venue review module 840 can generate input fields on a client device 852 that enable a player to identify a sports venue to the player networking service 810 and then add additional reviews for that sports venue. The venue review module 840 can generate text input fields on the client device 852 that enable text entry, star rating, number rating, etc., for a new venue review of a registered sports venue.

In one ore more embodiments, the venue review module 840 prompts the players to provide a venue review when the players participate in a sports match at one of the sports venues registered with the player networking service 810. For example, the venue review module 840 can prompt a player to enter a venue review at the completion of a sports match.

In one ore more embodiments, the venue review module 840 prompts the players to provide a venue review when the players participate in the sports match at one of the sports venues registered with the player networking service 810 but do not have a relevant venue review in the venue review store 830. For example, the venue review module 840 can prompt a player to enter a venue review at the completion of a sports match if the player does not already have a venue review in the venue review store 830 for the sports venue of the just completed sports match.

FIG. 8B shows a screen 860 on the client device 852 with a scrollable listing of player reviews for a venue—in this example, a tennis court venue at Prospect Park Tennis Center. In this example, the screen 860 includes star ratings and text reviews made by swupnilk and christina which are player handles for respective players registered with the player networking service 810.

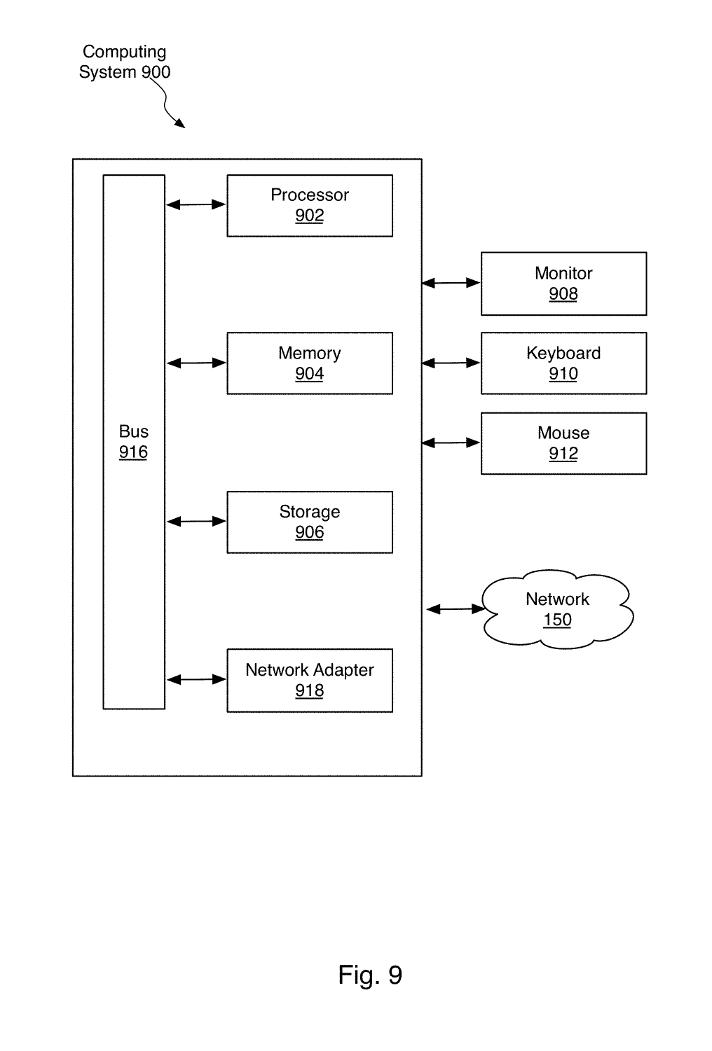

FIG. 9 illustrates a computing system 900 upon which portions of the player networking service 120 can be implemented. The computing system 900 includes one or more computer processor(s) 902, associated memory 904 (e.g., random access memory (RAM), cache memory, flash memory, etc.), one or more storage device(s) 906 (e.g., a hard disk, an optical drive such as a compact disk (CD) drive or digital versatile disk (DVD) drive, a flash memory stick, etc.), a bus 916, and numerous other elements and functionalities. The computer processor(s) 902 may be an integrated circuit for processing instructions. For example, the computer processor(s) may be one or more cores or micro-cores of a processor. The computing system 900 may also include one or more input device(s), e.g., a touchscreen, keyboard 910, mouse 912, microphone, touchpad, electronic pen, or any other type of input device. Further, the computing system 900 may include one or more monitor device(s) 908, such as a screen (e.g., a liquid crystal display (LCD), a plasma display, touchscreen, cathode ray tube (CRT) monitor, projector, or other display device), external storage, input for an electric instrument, or any other output device. The computing system 900 may be connected to the network 150 (e.g., a local area network (LAN), a wide area network (WAN) such as the Internet, mobile network, or any other type of network) via a network adapter 918.

While the foregoing disclosure sets forth various embodiments using specific diagrams, flowcharts, and examples, each diagram component, flowchart step, operation, and/or component described and/or illustrated herein may be implemented, individually and/or collectively, using a range of processes and components.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While the invention has been described with respect to a limited number of embodiments, those skilled in the art, having benefit of this disclosure, will appreciate that other embodiments may be devised which do not depart from the scope of the invention as disclosed herein.

What is claimed is:

1. A player network, comprising:
a device associated with a player in the player network that obtains a set of parameters pertaining to a sports match during a participation of the player in the sports match; and
a player networking service that obtains the parameters from the device and that in response to the parameters provides a user of the player networking service with access to a set of information pertaining to the sports match.

2. The player network of claim 1, wherein the information includes a score of the sports match.

3. The player network of claim 1, wherein the information includes a set of stats for the player.

4. The player network of claim 1, wherein the information includes a ranking of the player.

5. The player network of claim 1, wherein the information pertains to a venue for the sports match.

6. The player network of claim 1, wherein the player networking service enables the user to post a message pertaining to the sports match.

7. The player network of claim 1, wherein the device obtains a set of health information pertaining to the player.

8. The player network of claim 1, wherein the device includes a player interface that enables the player to provide a set of inputs describing the performance.

9. The player network of claim 8, wherein the device generates the parameters in response to the inputs.

10. The player network of claim 8, wherein the device runs an app adapted to a type of the sports match that generates the player interface and that generates the parameters.

11. The player network of claim 1, wherein the player networking service provides the user with a head-to-head comparison of a set of players of the player networking service selected by the user.

12. A method for a player network, comprising:
obtaining a set of parameters pertaining to a sports match during a participation of a player in the sports match; and
obtaining the parameters during the sports match and in response to the parameters providing a user of a player networking service with access to a set of information pertaining to the sports match.

13. The method of claim 12, wherein the information includes a score of the sports match.

14. The method of claim 12, wherein the information includes a set of stats for the player.

15. The method of claim 12, wherein the information includes a ranking of the player.

16. The method of claim 12, wherein the information pertains to a venue for the sports match.

17. The method of claim 12, further comprising generating a user interface to the player networking service that enables the user to post a message pertaining to the sports match.

18. The method of claim 12, further comprising obtaining a set of health information pertaining to the player.

19. The method of claim 12, wherein obtaining a set of parameters pertaining to a sports match during a participation of a player in the sports match comprises generating a player interface that enables the player to provide a set of inputs describing the performance.

20. The method of claim 19, further comprising generating the parameters in response to the inputs.

21. The method of claim 19, wherein providing a user of a player networking service with access to a set of information comprises providing the information to the user in a push notification.

22. The method of claim 12, further comprising displaying a head-to-head comparison of a set of players of the player networking service selected by the user.

23. A player networking service, comprising:
a venue registration module that enables a first player registered with the player networking service to use a client device of the first player to register a sports venue with the player networking service;
a venue review store for holding a set of venue reviews for the sports venue registered by the first player; and
a venue review module that enables a second player registered with the player networking service to access the venue reviews using a client device of the second player.

24. The player networking service of claim 23, wherein the venue registration module enables the first player to register the sports venue by enabling the first player to provide a set of descriptive information pertaining to the sports venue.

25. The player networking service of claim 24, wherein the venue review module enables the second player to search the venue review store from the client device of the second player using the descriptive information.

26. The player networking service of claim 24, wherein the venue review module enables the second player to add to the venue reviews in the venue review store from the client device of the second player using the descriptive information.

27. The player networking service of claim 23, wherein the venue review module prompts the second player to add to the venue reviews in the venue review store when the second player participates in a sports match at the sports venue.

28. The player networking service of claim 23, wherein the venue review module prompts the second player to add to the venue reviews in the venue review store when the second player has participated in a sports match at the sports venue but does not have a venue review for the sports venue recorded in the venue review store.
